(19) United States
(12) Patent Application Publication
(10) Pub. No.: US 2025/0392916 A1
(43) Pub. Date: Dec. 25, 2025

(54) INFORMATION PROCESSING DEVICE AND INFORMATION PROCESSING SYSTEM

(71) Applicant: PFU LIMITED, Ishikawa (JP)

(72) Inventor: Akifumi TAKAHASHI, Ishikawa (JP)

(21) Appl. No.: 19/243,978

(22) Filed: Jun. 20, 2025

(30) Foreign Application Priority Data
Jun. 21, 2024 (JP) 2024-100599

(51) Int. Cl. H04W 12/50; H04W 12/06; H04W 12/63; H04W 12/67; H04W 76/11; H04W 76/14; H04W 76/30

(52) U.S. Cl. CPC H04W 12/50; H04W 12/06; H04W 12/63; H04W 12/67; H04W 76/11; H04W 76/14; H04W 76/30

(57) ABSTRACT

An information processing device includes circuitry to receive a plurality of identifiers from an electronic apparatus that emits the plurality of identifiers each corresponding to one of a plurality of authentication methods. Each of the plurality of authentication methods has corresponding mis-pairing prevention performance regarding a risk of communicating with an unintended apparatus. The circuitry acquires predetermined information available for estimating the risk of communicating with the unintended apparatus, selects an authentication method having mis-pairing prevention performance suitable for the predetermined information from among the plurality of authentication methods, and performs authentication with the electronic apparatus using the selected authentication method for wireless communication in accordance with a wireless communication standard.

### CROSS-REFERENCE TO RELATED APPLICATIONS

This patent application is based on and claims priority pursuant to 35 U.S.C. § 119(a) to Japanese Patent Application No. 2024-100599, filed on Jun. 21, 2024, in the Japan Patent Office, the entire disclosure of which is hereby incorporated by reference herein.

### BACKGROUND

The present disclosure relates to an information processing device and an information processing system.

An information processing device has been proposed. Such an information processing device includes a wireless communication interface compliant with the BLUETOOTH low energy (BLE) standard, a means for intermittently emitting a first beacon signal that does not include predetermined information via the wireless communication interface, a means for emitting a second beacon signal including the predetermined information via the wireless communication interface, based on a condition being met, and a means for performing communication with a source terminal of a response, based on the response to the second beacon signal, in accordance with the predetermined information. The predetermined information is information for specifying processing to be executed via BLE wireless communication after a connection relationship has been established.

### SUMMARY

The information processing device according to one aspect of the present disclosure includes circuitry to receive a plurality of identifiers from an electronic apparatus that emits the plurality of identifiers each corresponding to one of a plurality of authentication methods. Each of the plurality of authentication methods has corresponding mis-pairing prevention performance regarding a risk of communicating with an unintended apparatus. The circuitry acquires predetermined information available for estimating the risk of communicating with the unintended apparatus, selects an authentication method having mis-pairing prevention performance suitable for the predetermined information from among the plurality of authentication methods, and performs authentication with the electronic apparatus using the selected authentication method for wireless communication in accordance with a wireless communication standard.

The information processing device according to another aspect of the present disclosure includes circuitry to receive a plurality of identifiers corresponding to a plurality of authentication methods from an electronic apparatus, select an authentication method for authentication of the electronic apparatus from among the plurality of authentication methods based on predetermined information available for estimating a risk of communicating with an unintended apparatus, and perform the authentication of the electronic apparatus using the selected authentication method.

The information processing system according to still another aspect of the present disclosure includes an electronic apparatus including first circuitry, and an information processing device including second circuitry. The information processing device performs authentication for wireless communication in accordance with a wireless communication standard with the electronic apparatus. The first circuitry emits a plurality of identifiers corresponding to a plurality of authentication methods each having corresponding mis-pairing prevention performance regarding a risk of communicating with an unintended apparatus. The second circuitry receives the plurality of identifiers, acquires predetermined information available for estimating the risk of communicating with the unintended apparatus, selects an authentication method having mis-pairing prevention performance suitable for the predetermined information from among the plurality of authentication methods, and perform the authentication with the electronic apparatus using the selected authentication method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a system according to an embodiment;

FIG. 2 is a schematic diagram illustrating a functional configuration of an electronic apparatus (scanner) according to an embodiment;

FIG. 3 is a schematic diagram illustrating a functional configuration of an information processing device (user terminal) according to an embodiment;

FIG. 4 is a diagram illustrating an example of a model selection screen according to an embodiment;

FIG. 5 is a diagram illustrating an example of a scanner search screen according to an embodiment;

FIG. 6 is a diagram illustrating an example of an approach instruction screen according to an embodiment;

FIG. 7 is a flowchart and communication sequence diagram illustrating an overview of a pairing process according to an embodiment;

FIG. 8 is another flowchart and communication sequence diagram illustrating an overview of a pairing process according to an embodiment;

FIG. 9 is still another flowchart and communication sequence diagram illustrating an overview of a pairing process according to an embodiment;

FIG. 10 is a schematic diagram illustrating a functional configuration of an information processing device (user terminal) according to a first variation;

FIG. 11 is a flowchart and communication sequence diagram illustrating an overview of a pairing process according to the first variation;

FIG. 12 is a flowchart and communication sequence diagram illustrating an overview of a pairing process according to a second variation; and

FIG. 13 is a flowchart and communication sequence diagram illustrating an overview of a pairing process according to a third variation.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing device, a system, a method, and a program according to embodiments of the present disclosure are described below with reference to the drawings. Embodiments described below are illustrative, and do not limit the information processing device, the information processing system, the method, and the program according to the present disclosure to the specific configurations described below. In the implementation, specific configurations may be adopted appropriately according to the mode of implementation, and various improvements and modifications may be made.

In the present embodiment described below, the information processing device, the system, the method, and the program according to some aspects of the present disclosure are applied to a system that establishes wireless communication according to BLUETOOTH. However, the information processing device, the information processing system, the method, and the program according to embodiments of the present disclosure can be widely applicable to a technique of establishing wireless communication in accordance with any wireless communication standard, and what the present disclosure is applied is not limited to those described below.

In the related art, pairing is performed when wireless communication is established according to a wireless communication standard such as BLUETOOTH between an information processing device (e.g., a smartphone or a personal computer (PC)) and an electronic apparatus (e.g., a peripheral apparatus such as a scanner). However, simplifying a user operation in the authentication (authentication procedure) during such pairing increases the risk of communicating with an unintended apparatus or device (e.g., security risks related to wireless communication such as spoofing, a man-in-the-middle attack, and indiscriminate connection, and a risk of incorrect selection (misidentification) of an electronic apparatus). On the other hand, trying to avoid the risk of communicating with an unintended apparatus results in more complicated user operations for pairing, leading to an increase in the user's time and effort. In other words, achieving a balance between reducing the user's time and effort, ensuring security, and avoiding communication with an incorrectly selected apparatus is difficult.

For example, in BLUETOOTH pairing, multiple pairing methods (authentication methods, Association Models) are available, and four types of authentication methods, Just Works, Passkey Entry, Numeric Comparison, and Out-of-Band (OOB), are available. Just Works is an authentication method that does not involve a user operation such as an input operation of inputting a passkey (Personal Identification Number (PIN) code). In Just Works, a connection partner is typically authenticated automatically without a user operation. However, there are scanners (models) that require an operation to confirm whether to perform pairing (e.g., an operation of inputting Yes/No in response to the question, “Do you want to perform pairing?”). Therefore, Just Works is an authentication method that does not involve an operation other than an input operation for confirming permission to perform pairing. Further, Just Works is an authentication method that does not involve an operation (user operation) for confirming that a connection destination is correct, and may be referred to as an authentication method without authentication (pairing method without authentication) in the BLUETOOTH standard. Passkey Entry is an authentication method in which a 6-digit PIN code (number) is displayed on one of the devices to allow the user to confirm the PIN code and input the PIN code to the other of the devices. Numeric Comparison is an authentication method in which both devices display a 6-digit PIN code (number), and the user is caused to confirm whether the PIN codes of both devices are the same and input the check result. Out-of-Band is an authentication method that passes authentication information by a method other than BLUETOOTH, such as Near Field Communication (NFC) or Universal Serial Bus (USB). Therefore, the Out-of-Band authentication method requires another communication method or medium.

For the purpose of simplifying user operations (facilitating user convenience) and because scanners do not necessarily have a screen display with sufficient display capabilities, it is preferable to use Just Works. However, in Just Works, for example, pairing is completed without confirming whether the individual scanner selected by the user on the smartphone is an individual scanner that the user actually wants to pair with. That is, the connection destination is not confirmed to be correct. This can lead to a situation where the user fails to notice that the user has incorrectly selected a scanner or become the target of a spoofing attack. Although the user can verify that the scanner is correctly selected, in advance, by carefully checking the serial number or other information on the scanner. However, in practice, checking the back or the bottom of each scanner increases the user's time and effort and is not realistic.

Accordingly, in the system described in the present embodiment, an authentication method with mis-pairing prevention performance suitable for predetermined information available for estimating a risk of communicating with an unintended apparatus is selected, and authentication with the electronic apparatus is performed by the selected authentication method. In the following description, the term “mis-pairing prevention performance” refers to a level of capability to prevent communication with an unintended apparatus, and may simply be referred to as “mis-pairing prevention performance” or referred to as “mis-pairing prevention performance regarding a risk of communicating with an unintended apparatus.” This enables selection of an authentication method suitable for the risk of communicating with an unintended apparatus. That is, the risk of communicating with an unintended apparatus can be appropriately avoided. This can also reduce the risk of communicating with an unintended apparatus while reducing the user's time and effort spent in establishing a wireless connection (pairing).

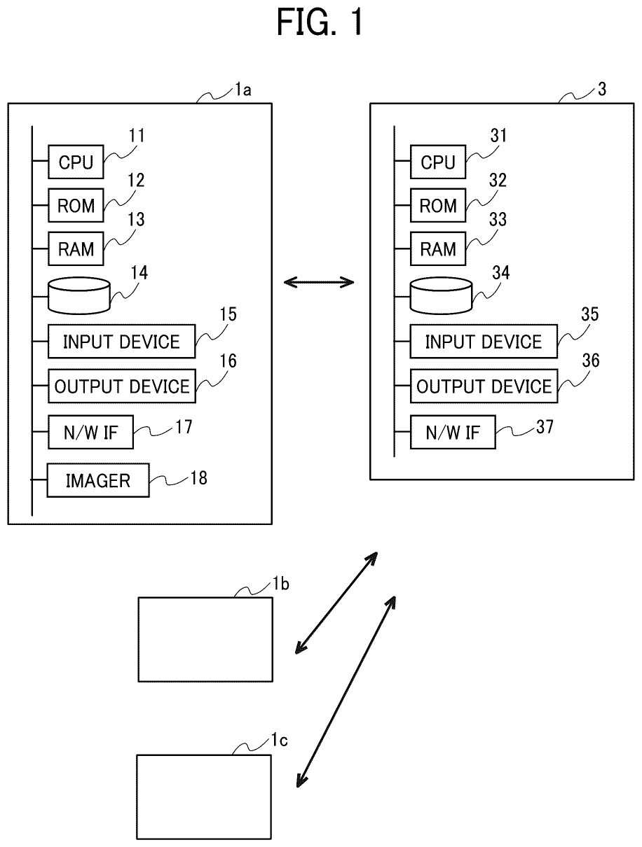

System Configuration FIG. 1 is a schematic diagram illustrating a configuration of a system according to the present embodiment. The system according to the present embodiment includes one or more electronic apparatuses 1 and an information processing device 3. In the present embodiment, the system includes three electronic apparatuses 1 (an electronic apparatus 1a, an electronic apparatus 1b, and an electronic apparatus 1c). However, the system may include any number of electronic apparatuses 1. The information processing device 3 and at least one electronic apparatus 1 establish wireless communication (wireless connection) in accordance with a predetermined wireless communication standard in response to a user operation performed on the information processing device 3. Each electronic apparatus 1 can be connected to (paired with) a plurality of information processing devices 3.

The electronic apparatus 1 (the electronic apparatus 1a, the electronic apparatus 1b, or the electronic apparatus 1c) can establish a wireless connection (wireless communication) with the information processing device 3. In the present embodiment, a scanner is used as an example of the electronic apparatus 1. In the following description, the electronic apparatus 1 (the electronic apparatus 1a, the electronic apparatus 1b, or the electronic apparatus 1c) is referred to as a scanner 1 (a scanner 1a, a scanner 1b, or a scanner 1c). The scanner 1 is an apparatus (peripheral device) that acquires image data by imaging documents, business cards, receipts, photographs/illustrations, etc., set by the user. The scanner 1 is a computer including a central processing unit (CPU) 11, a read-only memory (ROM) 12, a random-access memory (RAM) 13, a storage device 14 such as an electrically erasable programmable read-only memory (EEPROM) and a hard disk drive (HDD), an input device 15 such as a keyboard, a mouse, or a touch panel, an output device 16 such as a display, a communication unit 17 such as a network interface card (NIC), and an imager 18 to image a medium such as a document. Regarding the specific hardware configuration of the scanner 1, any component may be omitted, replaced, or added as appropriate according to a mode of implementation. Further, the scanner 1 is not limited to an apparatus having a single housing. The scanner 1 may be implemented by a plurality of apparatuses using, for example, a so-called cloud or distributed computing technology.

The scanner 1 may be a scanner that includes either the input device 15 or the output device 16. Alternatively, the scanner 1 may be a scanner that does not include either the input device 15 or the output device 16. The scanner 1a, the scanner 1b, and the scanner 1c may be scanners of the same model or scanners of different models from each other. In the present embodiment, the scanner 1 is used as an example of the electronic apparatus 1. However, the electronic apparatus 1 wirelessly connected to the information processing device 3 is not limited to a scanner. The electronic apparatus 1 may be another peripheral device (an output device such as a printer or a display, an input device such as a mouse or a keyboard, an auxiliary storage device, etc.). Further, the electronic apparatus 1 used in the present embodiment is merely an example, and any other apparatus (device) that can wirelessly connect to the information processing device 3 may also be used. The electronic apparatus 1a, the electronic apparatus 1b, and the electronic apparatus 1c may be the same type of electronic apparatus (e.g., all the electronic apparatuses are scanners), or may be different types of electronic apparatus (e.g., the electronic apparatus 1a is a scanner, and the electronic apparatus 1b is a printer).

The information processing device 3 is a computer including a CPU 31, a ROM 32, a RAM 33, a storage device 34, an input device 35 such as a keyboard, a mouse, or a touch panel, an output device 36 such as a display, and a communication unit 37 such as an NIC. Examples of the information processing device 3 includes a personal computer (PC), a smartphone, and a tablet. Regarding the specific hardware configuration of the information processing device 3, any component may be omitted, replaced, or added as appropriate according to a mode of implementation. Further, the information processing device 3 is not limited to an apparatus having a single housing. The information processing device 3 may be implemented by multiple apparatuses using, for example, a so-called cloud or distributed computing technology. In the present embodiment, the information processing device 3 is a terminal apparatus used by a user. In the following description, the information processing device 3 is referred to as a “user terminal 3.”

As described above, wireless communication (wireless connection) is established according to a predetermined wireless communication standard (referred to as a “first wireless communication standard” in the following description) between the electronic apparatus (scanner) 1 and the information processing device (user terminal) 3. In the present embodiment, BLUETOOTH, which is a short-range wireless communication standard, is used as an example of the “first wireless communication standard.” The “first wireless communication standard” may be, for example, BLUETOOTH Classic or BLUETOOTH Low Energy (BLE). In BLUETOOTH, a procedure (process) called “pairing” is performed to implement secure communication. In such “pairing,” the master device and the slave device each register the other and exchange keys (encryption keys) for data encryption. A procedure (process) for storing (saving) the encryption key exchanged by the pairing is called “bonding.” By bonding, when the device is reconnected to the same partner, the device can be connected to the partner without performing the pairing again, by using the stored encryption key. However, the electronic apparatus 1 and the information processing device 3 according to the present embodiment may or may not have a bonding function. In the present embodiment, BLUETOOTH is exemplified as the first wireless communication standard. However, the first wireless communication standard may be another wireless communication standard that involves pairing, such as ZIGBEE (registered trademark).

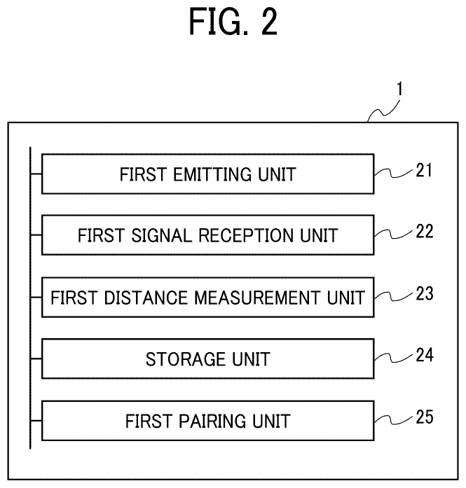

FIG. 2 is a schematic diagram illustrating a functional configuration of the electronic apparatus (scanner) 1 according to the present embodiment. The CPU 11 executes a program loaded onto the RAM 13 from the storage device 14, to control the hardware components of the electronic apparatus 1. Thus, the electronic apparatus 1 functions as an apparatus including a first emitting unit 21 (corresponding to the “emitting unit” of the electronic apparatus 1 of the present application), a first signal reception unit 22, a first distance measurement unit 23 (corresponding to the “measurement unit” of the electronic apparatus 1 of the present application), a storage unit 24, and a first pairing unit 25 (corresponding to the “disconnection unit” of the electronic apparatus 1 of the present application). In the present embodiment and other embodiments described below, the functions of the electronic apparatus 1 are executed by the CPU 11 which is a general-purpose processor. Alternatively, a part or all of these functions may be executed by one or multiple dedicated processors.

The first emitting unit 21 emits a predetermined signal (radio wave for connection (advertising (signal)). Advertising is a wireless signal that notifies nearby devices of the presence and information of the own apparatus (scanner 1). Advertising can include a service universally unique identifier (UUID) that can identify (indicate) the functions (services) that the own apparatus has. In the present embodiment, two authentication methods (Just Works and Passkey Entry) are used as examples of services employed by the scanner 1. That is, advertising emitted by the scanner 1 includes two service UUIDs, that is, a service UUID for identifying Just Works and a service UUID for identifying Passkey Entry. In the present embodiment, the scanner 1 holds the two UUIDs in advance and emits advertising including the two service UUIDs.

Just Works is an example of an “authentication method that does not involve an operation for confirming that a connection destination is correct.” Passkey Entry is an example of an “authentication method that involves an operation for confirming that a connection destination is correct.” Just Works does not involve an operation for confirming that the connection destination is correct. Passkey Entry is an authentication method that can prevent spoofing and indiscriminate connections due to failure to input a PIN code when the user is not at a position to view a display of the scanner. Accordingly, Just Works is considered an authentication method with low mis-pairing prevention performance regarding the risk of communicating with an unintended apparatus compared to Passkey Entry. The risk of communicating with an unintended apparatus includes a security risk related to wireless communication (e.g., a risk of being snooped) and a risk of misidentification of scanners. In the present embodiment, an “unintended apparatus” is an apparatus (device) that is not intended as a connection (pairing) target by the user. Such an apparatus (device) includes apparatuses (devices) that perform spoofing, man-in-the-middle attacks, or indiscriminate connections. The “unintended apparatus” may include an apparatus (device) incorrectly selected by the user (mistakenly identified apparatus (device)). That is, the “risk of communicating with an unintended apparatus” may include a risk of communicating with a scanner incorrectly or mistakenly selected (identified) by the user. As described above, in the present embodiment, the first emitting unit 21 emits a plurality of identifiers corresponding to a plurality of authentication methods. The authentication methods have varying mis-pairing prevention performance regarding the risk of communicating with an unintended apparatus. In the present embodiment, the “plurality of authentication methods” includes a first authentication method and a second authentication method. The second authentication method has lower mis-pairing prevention performance than the first authentication method. Passkey Entry corresponds to the “first authentication method” of the present application. Just Works corresponds to the “second authentication method” of the present application. However, the first authentication method may be, for example, Numeric Comparison or Out-of-Band. Numeric Comparison and Out-of-Band are examples of an “authentication method involving an operation for confirming that a connection destination is correct,” like Passkey Entry.

The first authentication method may be a method in which Just Works is combined with a method of requesting a predetermined operation to be performed related to the intended right scanner (an operation that requires the user to be physically near the scanner). The “predetermined operation” is an operation performed by the user related to a right electronic apparatus intended by the user as a connection target (pairing target), and is an operation instructed to be performed by the user. For example, after pairing using Just Works is completed, the user is instructed to perform a predetermined operation. The predetermined operation is an operation performed on the own apparatus (scanner 1) or the user terminal 3. The “right electronic apparatus intended by the user as a connection target” is an electronic apparatus that is desired by the user to be connected to the user terminal 3, for example, an electronic apparatus whose installed position is known by the user (such as an electronic apparatus where the user can visually recognize its position by standing in front of the electronic apparatus). The user can select the scanner 1 to be connected to the user terminal 3 on a scanner selection screen. However, the user may incorrectly select a wrong scanner (select a scanner that is not the intended scanner) on the scanner selection screen. In such a case, the scanner 1 selected by the user on the scanner selection screen does not correspond to the “right electronic apparatus (scanner) intended by the user as a connection target” in the present embodiment. As described above, the method in which Just Works and the method of causing a user to perform a predetermined operation are combined can confirm whether the scanner 1 that has completed the pairing with the user terminal 3 is the “right scanner intended by the user as a connection target” by causing the user to perform the predetermined operation after the pairing is completed.

For example, the predetermined operation is an operation of pressing a button (e.g., a scan button) on the right scanner. The button to be pressed may be a button displayed on a display of the scanner 1 or a button that is a component of the scanner 1. The predetermined operation may be an operation of placing (setting) a medium such as a document on the right scanner (media tray) or an operation for performing scan (activating a specific function) after placing a medium such as a document on the right scanner. Further, the predetermined operation may be an operation for activating another specific function of the scanner 1 instead of activating the scan function. Further, the predetermined operation may be an operation for restarting the right scanner. For example, the user may perform an operation of opening and closing the media tray cover to restart the scanner 1, when the scanner 1 is a scanner that is designed to be turned on and off by opening and closing the media tray cover, respectively. Further, the predetermined operation may be an operation of bringing the user terminal 3 close to the correct scanner (setting the distance between the correct scanner and the user terminal 3 to be less than a predetermined distance). Further, the predetermined operation may be an operation for performing wireless communication (for example, NFC communication) between the correct scanner and the user terminal in accordance with a wireless communication standard other than the first wireless communication standard. Further, the predetermined operation may be an operation of inputting a result obtained by the user confirming whether a predetermined output (e.g., output of a specific light, display of a specific screen, output of a specific sound, or generation of a specific vibration) for indicating that the scanner is a scanner that has completed pairing with the user terminal 3 is performed by the right scanner. Further, the predetermined operation may be an operation for capturing an image of the right scanner (identification information of the right scanner). Such an authentication method can be executed with a scanner that does not have an output device such as a display. Thus, even when the scanner does not have an output device, pairing can be performed while ensuring security by combining Just Works and a predetermined operation. However, the authentication method described in the present embodiment is an example, and any other authentication methods may be used.

The service UUID is a 128-bit value and represented as a character string that includes a hexadecimal string and a hyphen. The service UUID for identifying each of Just Works and Passkey Entry in the present embodiment is also a 128-bit value. For the sake of simplicity, the UUID for identifying Just Works is referred to as “UUID A,” and the UUID for identifying Passkey Entry is referred to as “UUID B” in the following description. The advertising may include any other information such as the address and the apparatus name of the own apparatus (scanner 1) in addition to the service UUID. The first emitting unit 21 periodically emits advertising (at a predetermined interval such as every second), but the emission cycle may be any cycle. The first emitting unit 21 may emit two signals, that is, an advertising signal including UUID A and an advertising signal including UUID B. The number of UUIDs (corresponding to authentication methods) for identifying authentication methods (the number of authentication methods) transmitted from the scanner is not limited to two, and three or more UUIDs may be transmitted. The identification information (identifier) corresponding to an authentication method is not limited to the service UUID, and other identification information may be used.

The first signal reception unit 22 receives a signal from another device. For example, the first signal reception unit 22 receives a signal that is emitted by the user terminal 3 (the second emitting unit 41) and can be used for distance measurement.

The first distance measurement unit 23 measures the distance between the own apparatus (scanner 1) and another device. For example, the first distance measurement unit 23 measures the distance between the own apparatus and the user terminal 3 using the signal received by the first signal reception unit 22 (the signal emitted from the user terminal 3).

The storage unit 24 stores information on the user terminal 3 (information for identifying the user terminal 3) whose distance from the scanner 1 measured by the first distance measurement unit 23 meets a predetermined condition. For example, information on the user terminal 3 whose distance from the scanner 1 measured by the first distance measurement unit 23 is less than a predetermined value (for example, 10 cm) is stored. The information on the user terminal 3 may be the device name, the serial number, or the address information of the user terminal 3.

The first pairing unit 25 receives a pairing request for wireless communication in accordance with a first wireless communication standard (BLUETOOTH) from the user terminal 3. Upon receiving a pairing request, the first pairing unit 25 performs pairing (including authentication) between the own apparatus (scanner 1) and the user terminal 3 that is the source of the pairing request, and completes (establishes) the pairing. For example, when receiving a pairing request specifying the UUID A from the user terminal 3, the first pairing unit 25 performs pairing (authentication) using the authentication method (Just Works) corresponding to the UUID A. Further, for example, when receiving a pairing request specifying the UUID B from the user terminal 3, the first pairing unit 25 performs pairing (authentication) using the authentication method (Passkey Entry) corresponding to the UUID B. At this time, the first pairing unit 25 transmits a pairing response to the user terminal 3, which is the source of the pairing request. As a result, a connection for wireless communication (first wireless communication) in accordance with the first wireless communication standard is established between the scanner 1 and the user terminal 3. The first pairing unit 25 cancels pairing as appropriate. For example, the first pairing unit 25 disconnects the wireless communication when the distance measured by the first distance measurement unit 23 does not meet a predetermined condition. For example, when the user terminal 3 determines that the distance between the user terminal 3 and the scanner 1 is less than the predetermined distance, the authentication by Just Works is executed between the scanner 1 and the user terminal 3. However, in such a case, when the distance between the devices measured by the scanner 1 (first distance measurement unit 23) is determined not to be less than the predetermined distance (when the information on the user terminal 3 is not stored in the storage unit 24), the first pairing unit 25 may disconnect the wireless communication established by the authentication by Just Works. In this way, the first pairing unit 25 performs various processing related to pairing (which may include, in addition to the above-described processing, exchanging encrypted information (encryption key)).

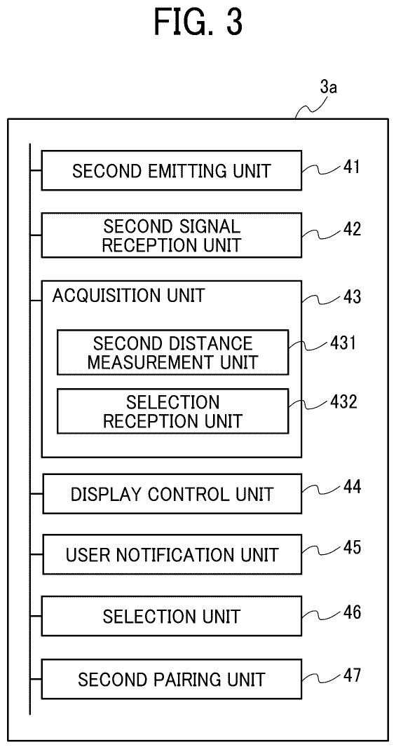

FIG. 3 is a schematic diagram illustrating a functional configuration of the information processing device (user terminal) 3a according to the present embodiment. The CPU 31 executes a program loaded onto the RAM 33 from the storage device 34, to control the hardware components of the information processing device 3. Thus, the information processing device 3 functions as a device including a second emitting unit 41 (corresponding to the “emitting unit” of the information processing device 3 of the present application), a second signal reception unit 42 (corresponding to the “reception unit” of the information processing device 3 of the present application), an acquisition unit 43, a display control unit 44, a user notification unit 45 (corresponding to the “notification unit” of the information processing device 3 of the present application), a selection unit 46, and a second pairing unit 47 (corresponding to the “authentication unit” of the information processing device 3 of the present application). In the present embodiment and other embodiments described below, the functions of the information processing device 3 are executed by the CPU 31 which is a general-purpose processor. Alternatively, a part or all of these functions may be executed by one or multiple dedicated processors.

The second emitting unit 41 emits a signal. The second emitting unit 41 may emit any signal (e.g., advertising signal) as long as the signal is a radio wave (signal) that can be used for distance measurement. When the user terminal 3 is not a mobile terminal, the user terminal 3 may not include the second emitting unit 41.

The second signal reception unit 42 receives a signal from another device. In the present embodiment, the second signal reception unit 42 receives advertising (signal) emitted by the scanner (first emitting unit 21). For example, the second signal reception unit 42 receives advertising from each of one or more scanners 1 (e.g., scanner 1a, scanner 1b, and/or scanner 1c illustrated in FIG. 1). Accordingly, the user terminal 3 can acquire information on nearby electronic apparatuses, and can recognize what kinds of electronic apparatuses are present in the vicinity. In the present embodiment, the user terminal 3 (second signal reception unit 42) receives a plurality of identifiers (the service UUID (UUID A) for identifying Just Works and the service UUID (UUID B) for identifying Passkey Entry) corresponding to a plurality of authentication methods from the scanner 1 (first emitting unit 21).

The acquisition unit 43 acquires predetermined information available for estimating a risk of communicating with an unintended apparatus (a security risk related to wireless communication or a risk of misidentification of electronic apparatuses). This predetermined information is referred to as “predetermined information” in the following description. The acquisition unit 43 includes a second distance measurement unit 431 and a selection reception unit 432.

The second distance measurement unit 431 measures the distance between the own device (user terminal 3) and another device (apparatus). For example, the second distance measurement unit 431 measures the distance between the own device and the scanner 1 by using the signal received by the second signal reception unit 42 (the signal emitted from the scanner 1). The second distance measurement unit 431 measures a distance to each of one or more scanners (for example, scanner 1a, scanner 1b, and/or scanner 1c) that can perform authentication for wireless communication in accordance with a predetermined wireless communication standard. In general, a risk including a security risk and a risk of misidentification of scanners varies depending on the distance between the user terminal 3 and the scanner 1. For example, when the user terminal 3 is connected to the scanner 1 via BLUETOOTH (pairing), a malicious user may impersonate a scanner and eavesdrop on or tamper with the communication data transmitted from the user terminal 3. However, when the distance between the user terminal 3 and the scanner 1 is short (when the user terminal 3 and the scanner 1 are nearby), this can prevent a third party from interfering with the pairing. In addition, the short distance allows the user to visually notice that any third-party attempts to interrupt the pairing. This allows the user to be aware of snooping. In the description, the distance between the user terminal 3 and the scanner 1 being short means that the user terminal 3 is located less than a predetermined distance from the scanner 1, namely, the distance between the user terminal 3 and the scanner 1 is less than the predetermined distance. The predetermined distance can be set by a designer to, for example, 10 cm. Further, for example, when the distance between the scanner 1 and the user terminal 3 is short (when the user terminal 3 and the scanner 1 are nearby), it can be inferred that the user has approached or is near the scanner 1 that is a scanner to be connected (paired). Accordingly, when the distance between the scanner 1 and the user terminal 3 is short, the risk of communicating with a scanner other than the scanner intended by the user as the connection destination is estimated to be low. Accordingly, when the distance between the user terminal 3 and the scanner 1 is short, the risk of communicating with an unintended apparatus (the risk of being spoofed or the risk of misdetection of scanners) can be estimated to be lower than when the distance between the user terminal 3 and the scanner 1 is long (when the user terminal 3 and the scanner 1 are far apart). In the description, the distance between the user terminal 3 and the scanner 1 being long means that the user terminal 3 is not less than the predetermined distance from the scanner 1, namely, the distance between the user terminal 3 and the scanner 1 is not less than the predetermined distance or is equal to or greater than the predetermined distance. The predetermined distance can be set by a designer to, for example, 10 cm. That is, the distance between the user terminal 3 and the scanner 1 can be considered as information available for estimating the risk of communicating with an unintended apparatus. Accordingly, the distance between the user terminal 3 and the scanner 1 is an example of the predetermined information. As described above, the acquisition unit 43 can acquire the distance between the own device and the scanner 1 as the predetermined information by the second distance measurement unit 431 measuring the distance.

The selection reception unit 432 receives selection of a scanner (operation for specifying a scanner) for a wireless connection (pairing (including authentication)) in accordance with the first wireless communication standard (BLUETOOTH) with the user terminal 3. The selection reception unit 432 receives a user operation for selecting a scanner to be wirelessly connected. For example, the selection reception unit 432 receives an input operation for scanner selection performed by the user on a scanner selection screen displayed by the display control unit 44. When a user operation is performed on a screen such as the scanner selection screen to select a scanner to be connected (used), there is a risk that the user may incorrectly select a scanner other than the intended scanner. By contrast, when the user terminal 3 is brought close to the scanner 1 to select the scanner 1 as a scanner to be used, the risk of the user incorrectly selecting a scanner other than the intended scanner decreases. Accordingly, when a scanner to be subjected to authentication is selected (specified) on a screen such as the scanner selection screen, the risk of communicating with an unintended apparatus (the risk of incorrectly selecting a scanner) can be estimated to be higher than when a scanner is selected by a method other than one involving the screen. That is, information indicating whether the scanner has been selected (specified) as a scanner to perform authentication with the own device can be considered as information available for estimating the risk of communicating with an unintended apparatus. Accordingly, the information indicating whether the scanner is selected (specified) as a scanner to perform authentication with the own device is an example of the predetermined information. As described above, the acquisition unit 43 can acquire, as the predetermined information, the information indicating whether the scanner has been selected (specified) as a scanner to perform the authentication with the own device by the selection reception unit 432 receiving a user operation for scanner selection.

The display control unit 44 displays various screens via the output device 36. For example, the display control unit 44 displays a screen for allowing the user to select a type (model) of a scanner to be used (the screen for selecting a type is different from a screen for selecting a scanner).

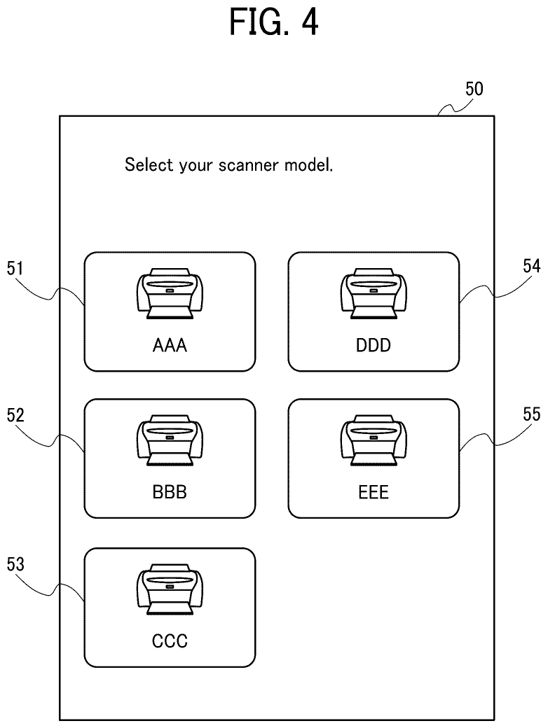

FIG. 4 is a diagram illustrating an example of a model selection screen according to the present embodiment. FIG. 4 illustrates a model selection screen 50 displayed on a display (output device 36) of the user terminal 3. For example, the model selection screen 50 is displayed on the display of the user terminal 3 when a scanner application (such as an initial settings wizard) is started according to a user operation performed on the user terminal 3. As illustrated in FIG. 4, information on one or more scanner models is displayed on the model selection screen 50. Specifically, the model selection screen 50 includes a display component 51 indicating information on a scanner model AAA, a display component 52 indicating information on a scanner model BBB, a display component 53 indicating information on a scanner model CCC, a display component 54 indicating information on a scanner model DDD, and a display component 55 indicating information on a scanner model EEE. Each of the display components 51 to 55 may include any information such as a model name and an exterior diagram (exterior photo) of the corresponding scanner model. However, the model selection screen is not limited to the example of FIG. 4, and may be a screen including any components.

The model selection screen may be displayed as appropriate, and the model selection screen may not be displayed in some embodiments in which model selection is not necessary.

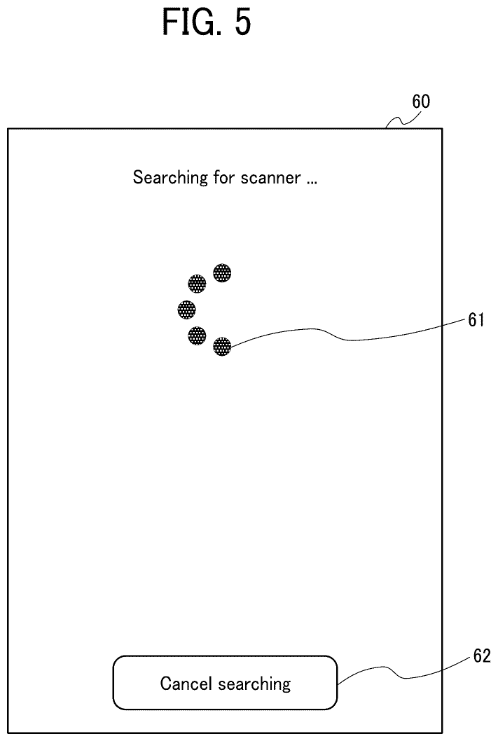

FIG. 5 is a diagram illustrating an example of a scanner search screen according to the present embodiment. FIG. 5 illustrates a scanner search screen 60 displayed on the display (output device 36) of the user terminal 3. For example, the scanner search screen 60 is displayed when a model is selected on the model selection screen 50. As illustrated in FIG. 5, the scanner search screen 60 includes a message indicating that a scanner is being searched for (“Searching for scanner”), an image 61 indicating that a scanner is being searched for, and a button 62 for canceling the search for a scanner (“Cancel searching” button in FIG. 5). However, the scanner search screen may be displayed as appropriate. The scanner search screen is not limited to the example of FIG. 5, and may be a screen including any components.

The display control unit 44 also displays information on connectable scanners (for example, a list of connectable scanners). The display control unit 44 displays information on the scanners 1 (for example, the scanner 1a, the scanner 1b, and the scanner 1c illustrated in FIG. 1) that are sources of the advertising received by the second signal reception unit 42. The list of connectable scanners may be displayed on a screen (scanner selection screen) available for selecting a scanner. “Information on a scanner” to be displayed may be any information such as a product name, an identification number, and an exterior diagram (exterior photo) of the scanner 1. The display control unit 44 may also display another screen such as a screen for connecting to WI-FI (registered trademark) (a screen for inputting a service set identifier (SSID), password information, etc.) or a screen indicating that WI-FI settings are complete.

The user notification unit 45 outputs a notification to notify the user of various information. For example, the user notification unit 45 outputs a notification to instruct (prompt) the user to approach the scanner to be used (the intended scanner). For example, the user notification unit 45 outputs the notification by displaying a message prompting the user to bring the user terminal 3 close to the scanner to be used, via the output device 36.

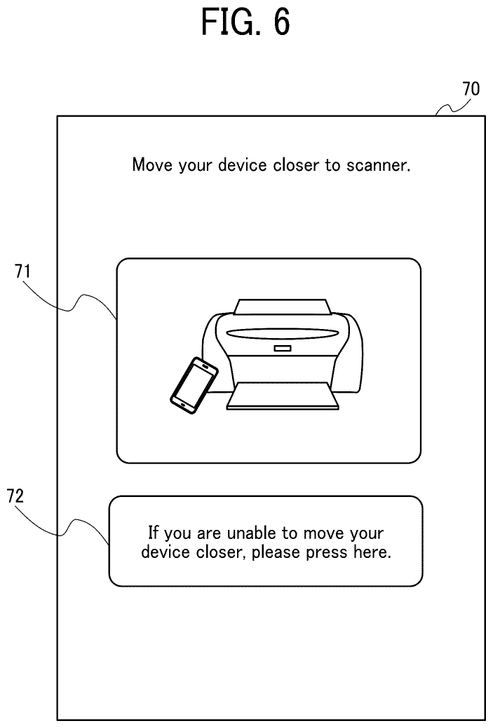

FIG. 6 is a diagram illustrating an example of an approach instruction screen according to the present embodiment. FIG. 6 illustrates an approach instruction screen 70 displayed on the display (output device 36) of the user terminal 3. For example, the approach instruction screen 70 is displayed when a scanner corresponding to the model selected by the scanner search is found. As illustrated in FIG. 6, the approach instruction screen 70 includes a message prompting the user to bring the user terminal 3 close to the scanner to be used (“Move your device closer to scanner.”), an image 71 indicating that the user terminal 3 is brought close to the scanner 1, a button 72 to be pressed when the user fails to approach the scanner 1 (the user terminal 3 fails to be brought close to the scanner 1). However, the approach instruction screen is not limited to the example of FIG. 6, and may be a screen including any components.

Further, the user notification unit 45 may output a notification indicating that an error has occurred (error notification). For example, the user notification unit 45 outputs an error notification when the distance between the own device and the scanner 1 measured by the scanner 1 does not meet a predetermined condition. The scanner 1 has received a signal emitted by the second emitting unit 41 and measures the distance between the information processing device and the scanner 1 by using the received signal. For example, when the distance between the own device and the scanner 1 measured by the scanner 1 is not less than a predetermined distance (for example, 10 cm), and as a result, information on the own device is not stored as the user terminal 3 being at a short distance by the storage unit 24, the user terminal 3 may output an error notification to notify the user of an error. The “predetermined condition” may be the same as or different from a “distance-related condition,” which is described later.

Any suitable method may be used for the notification. For example, the notification may be output by displaying a message prompting the user to approach a scanner to be used or information indicating an error via the output device 36. In this case, the display control unit 44 may function as the user notification unit 45. Further, the notification includes a message prompting the user to approach a scanner to be used and information indicating that an error may be output by audio (voice).

The selection unit 46 selects an authentication method (service UUID) used for authentication. Specifically, the selection unit 46 selects an authentication method to be used for authentication from the plurality of authentication methods corresponding to the plurality of identifiers received by the second signal reception unit 42 based on a predetermined criterion. In the present embodiment, the selection unit 46 selects an authentication method with mis-pairing prevention performance suitable for the predetermined information acquired by the acquisition unit 43 from among the plurality of authentication methods. As with the scanner 1, the user terminal 3 may also pre-store the service UUID and information indicating what service the service UUID identifies in association with each other. For example, the UUID A and the service “Just Works” are stored in association with each other, and the UUID B and the service “Passkey Entry” are stored in association with each other. Thus, the selection unit 46 can determine the service UUID used for authentication. In the present embodiment, selecting an authentication method also means selecting a service UUID. In the present embodiment, the service UUID and the service are pre-stored in association with each other in the scanner 1 and the user terminal 3. However, the user terminal 3 may acquire the service UUID identifying the service by another method. A specific example of a method of selecting an authentication method is described below.

### Method of Selecting Authentication Method Based on Distance

The selection unit 46 selects an authentication method with mis-pairing prevention performance suitable for the distance between the scanner 1 and the own device. The distance is acquired (measured) by the acquisition unit 43 (second distance measurement unit 431). For example, as described above, when the distance between the scanner 1 and the own device is short, the scanner 1 is highly probable to be a scanner that the user wants to use (the user is highly likely to have approached the scanner that the user wants to use), and thus the risk of communicating with an unintended scanner is estimated to be low (or none). As described above, when the risk of communicating with an unintended scanner can be estimated to be low, it can be determined that an authentication method with low (relatively low) mis-pairing prevention performance may be used. Further, a user operation related to authentication (pairing) is simple in most cases of authentication methods with low mis-pairing prevention performance such as Just Works. Accordingly, when the risk of communicating with an unintended scanner can be estimated to be low, the user operation related to pairing can be facilitated (simplified) by using an authentication method with low mis-pairing prevention performance. As described above, the selection unit 46 may select an authentication method with mis-pairing prevention performance suitable for a situation. For example, the situation is that the distance between the own device and the scanner 1 is short, and in such a case, the risk of communicating with an unintended apparatus can be estimated to be low, and the selection unit 46 may select an authentication method with low mis-pairing prevention performance. In the present embodiment, when the distance between the scanner 1 and the own device meets a condition related to distance, the selection unit 46 selects an authentication method with relatively low mis-pairing prevention performance (second authentication method) for authentication with the scanner 1. The condition related to distance may be referred to as a “distance-related condition” in the following description. The “distance-related condition” may be, for example, a condition that the distance is less than a predetermined distance, or a condition that the distance is within a predetermined range.

The “predetermined distance” may be set to any value, such as 10 cm to prevent third-party interference, or 1 m to allow detection of such interference by the user. In the present embodiment, the second authentication method is selected when the distance between the scanner 1 and the own device meets the distance-related condition within a predetermined time period (for example, a predetermined time (short time) such as several tens of seconds or several minutes from the time when the instruction to bring the user terminal 3 close to the scanner 1 is given). The “predetermined time period (predetermined time)” may be pre-stored in the user terminal 3, or may be received from the scanner 1. The “predetermined time period” and the “predetermined time” may be fixed or may be set to be dynamically changeable by at least the scanner 1 or the user terminal 3 according to at least one of a user characteristic, the details of settings of the own apparatus, and the details of settings of the user terminal 3. For example, the predetermined time (waiting time) is dynamically changed according to a user characteristic indicating that the user is extremely slow in operation in the initial settings wizard of the scan application. In this case, the user is assumed to be unfamiliar with the apparatus, and the predetermined time (waiting time) may be extended for a longer period (e.g., doubled) accordingly.

Further, for example, as described above, when the distance between the scanner 1 and the own device is large, the risk of communicating with an unintended scanner can be estimated to be higher than when the distance between the scanner 1 and the own device is short. As described above, when the risk of communicating with an unintended scanner can be estimated to be high (or present), it can be determined that an authentication method with high (relatively high) mis-pairing prevention performance may be appropriate to be used. As described above, when the risk of communicating with an unintended scanner can be estimated to be high, the risk can be avoided by using an authentication method with high (relatively high) mis-pairing prevention performance. As described above, the selection unit 46 may select an authentication method with mis-pairing prevention performance suitable for a situation. For example, the situation is that the distance between the own device and the scanner 1 is long, and in such a case, the risk of communicating with an unintended apparatus can be estimated to be high, and the selection unit 46 may select an authentication method with high mis-pairing prevention performance. In the present embodiment, when the distance between the scanner 1 and the own device does not meet the distance-related condition (for example, when the distance between the devices is equal to or greater than the predetermined distance), the selection unit 46 selects an authentication method with relatively high mis-pairing prevention performance (first authentication method) for authentication with the scanner 1. For example, when the user selects a scanner on the scanner selection screen, the user terminal 3 may measure the distance between the selected scanner and the user terminal 3, and when the measured distance is larger than a predetermined distance, it may be determined (selected) that authentication is to be performed with the selected scanner by the first authentication method. Further, for example, when the distance between the scanner 1 and the own device 3 does not meet the distance-related condition within a predetermined time period, the first authentication method may be selected as the authentication method for authentication with the scanner 1.

A scanner to be paired may be determined by bringing the user terminal 3 close to the scanner 1 in accordance with the approach instruction (instruction to prompt the user to bring the user terminal 3 to close to the scanner 1). That is, the scanner 1 to which the user has approached while carrying the user terminal 3 or the scanner 1 located near the user terminal 3 may be determined as a scanner to be paired with the user terminal 3.

### Method of Selecting Authentication Method Based on Whether Scanner is Specified

The selection unit 46 selects an authentication method with mis-pairing prevention performance suitable for information indicating whether the scanner 1 is specified as a target apparatus to be paired with the user terminal 3 (whether the scanner 1 is specified (selected) as a connection target). The pairing process includes authentication. The information is acquired by the acquisition unit 43 (selection reception unit 432). When a scanner to be subjected to authentication is selected (specified) on the scanner selection screen as described above, the risk of the user incorrectly selecting a scanner (the risk of communicating with an unintended apparatus) can be estimated to be high. As described above, when the risk is high, an authentication method with high (relatively high) mis-pairing prevention performance is preferably used. Accordingly, when the scanner 1 is specified, for example, on the scanner selection screen by the user, the selection unit 46 selects an authentication method with relatively high mis-pairing prevention performance (first authentication method) for authentication with the scanner 1.

As described above, the selection unit 46 may select the second authentication method when the acquisition unit 43 acquires information available for estimating that the risk of communicating with an unintended apparatus is none or low. That is, when the risk can be estimated to be low or none, the pairing method for connection may prioritize facilitating the user operation. Further, the selection unit 46 may select the first authentication method when the acquisition unit 43 acquires information available for estimating that the risk of communicating with an unintended apparatus is present or high. That is, in this case, the pairing method for connection may prioritize avoiding (reducing) the risk of communicating with an unintended apparatus (ensuring security, etc.).

The second pairing unit 47 performs pairing (including authentication) for wireless communication with the scanner 1 in accordance with a predetermined wireless communication standard. In the present embodiment, the second pairing unit 47 performs authentication with the scanner 1 by an authentication method selected by the selection unit 46. For example, the second pairing unit 47 transmits a pairing request to the scanner 1 by specifying a service UUID (for example, UUID A) for identifying an authentication method (for example, Just Works) selected by the selection unit 46, and performs authentication (pairing) with the scanner 1 by the selected authentication method (for example, Just Works). The second pairing unit 47 may determine, as a target scanner to be paired (authenticated) with the own device, a scanner whose distance from the own device, acquired (measured) by the acquisition unit 43, meets the distance-related condition (for example, a scanner whose distance from the own device is less than 10 cm), among one or more connectable scanners 1. That is, the scanner 1 to be paired with the user terminal 3 may be determined by bringing the user terminal 3 close to the scanner 1. As described above, the second pairing unit 47 performs various processes related to pairing (which may include a process of exchanging encryption information (encryption key) in addition to the above-described processes).

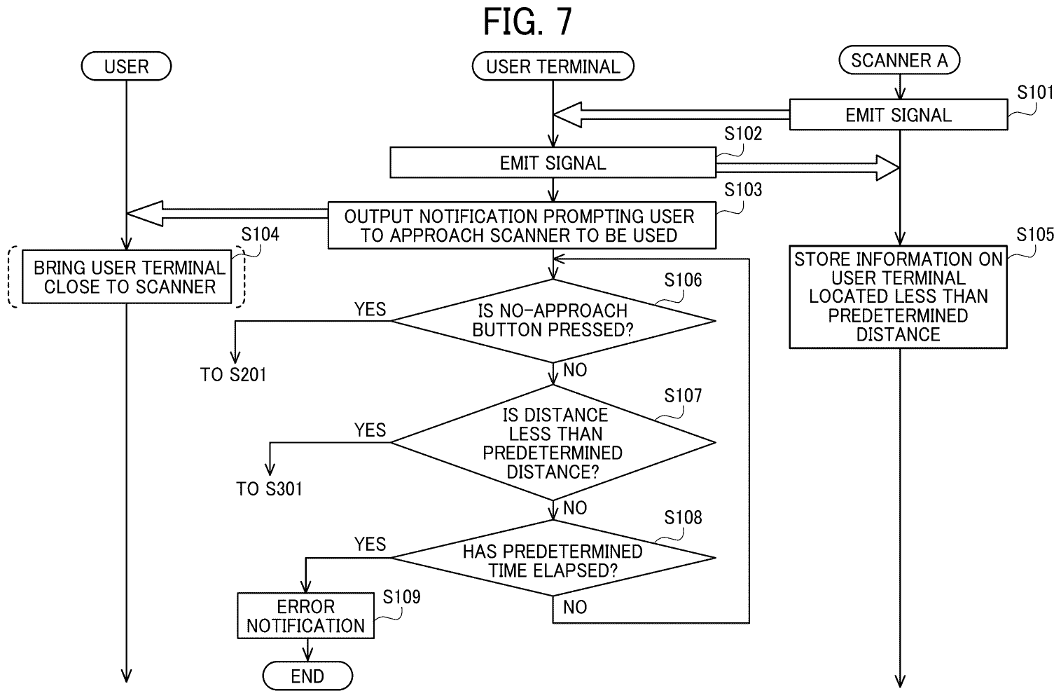

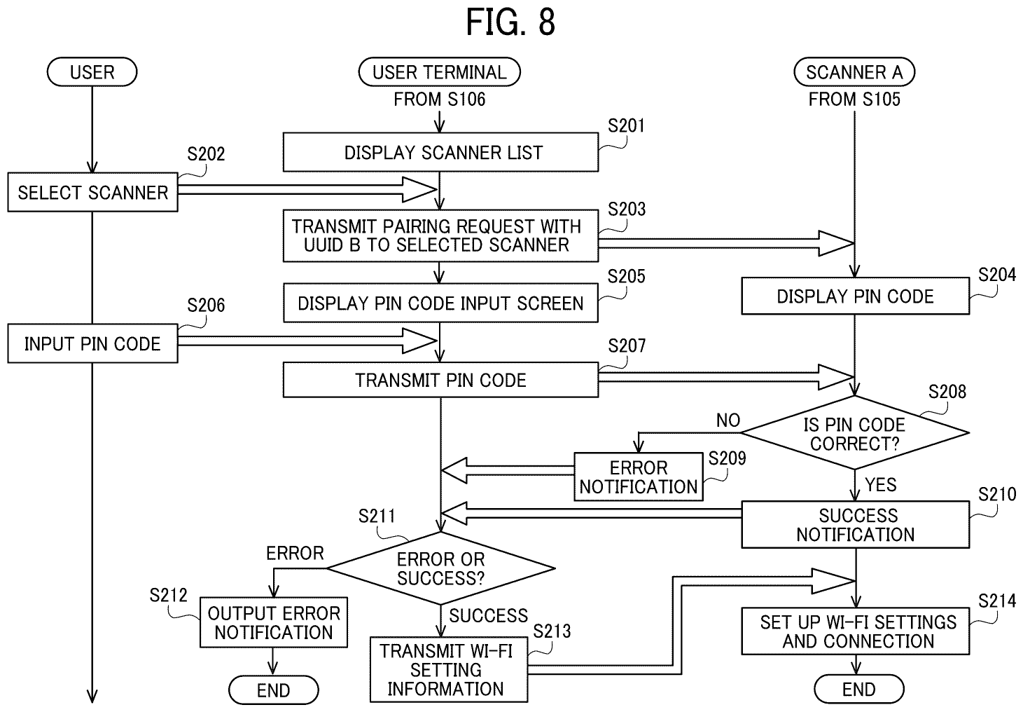

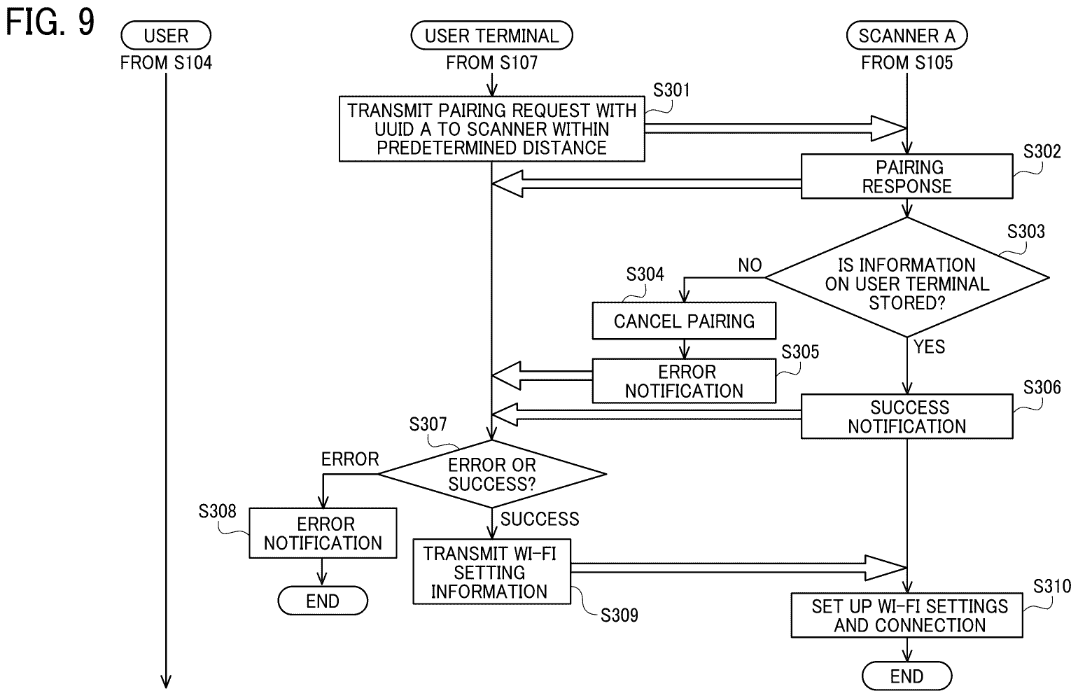

FIGS. 7 to 9 are flowcharts and communication sequence diagrams each illustrating an overview of a pairing process according to the present embodiment. In the present embodiment, the scanner 1 is assumed to either always allow BLUETOOTH pairing, or allow pairing to be established with a very simple operation (e.g., by long-pressing the BLUETOOTH icon). The process illustrated in the flowchart starts in response to a user operation performed on the user terminal 3 for starting a scanner application (such as an initial settings wizard). Alternatively, for example, the process illustrated in the flowchart may start when a scanner model is selected on the model selection screen of FIG. 4. “USER” in FIGS. 7 to 9 and 11 to 13 indicates the user of the “user terminal.” In the following description, the scanner 1 paired with the user terminal 3 is referred to as a “scanner A.” The scanner A may be, for example, the scanner 1a.

In Steps S101 and S102, each of the scanner 1 and the user terminal 3 emits advertising, and both the scanner 1 and the user terminal 3 receive the advertising emitted from the counterpart device, thereby initiating the measurement of the distance between the own device and the counterpart device. The measurement of the distance is performed by the first distance measurement unit 23 and the second distance measurement unit 431. For example, the distance measurement is performed multiple times within a predetermined time period (for example, each time a signal is received). In Step S101, the first emitting unit 21 emits advertising, and the second signal reception unit 42 receives the advertising emitted by the first emitting unit 21. The user terminal 3 (second signal reception unit 42) receives advertising from each of one or more scanners 1 (e.g., the scanner 1a, the scanner 1b, and/or the scanner 1c illustrated in FIG. 1). In Step S102, the second emitting unit 41 emits advertising, and the first signal reception unit 22 receives the advertising emitted by the second emitting unit 41. The first emitting unit 21 and the second emitting unit 41 may emit advertising before the scanner application is started by the user. The scanner 1 and the user terminal 3 may periodically emit advertising. Further, when the user terminal 3 is not a mobile terminal, the processing of Step S102 may not be performed. In the example of the flowchart, the advertising transmitted from the scanner A (scanner 1a) includes at least the service UUID (UUID A) for identifying Just Works and the service UUID (UUID B) for identifying Passkey Entry. The timing when the distance measurement starts may be another timing such as a timing when an approach instruction is given to the user. For example, the scanner A may perform distance measurement when receiving a pairing request from the user terminal 3. The order of Steps S101 and S102 may also be reversed. The process then proceeds to Steps S103 and S105.

In Step S103, the user terminal 3 outputs a notification prompting the user to approach the scanner to be used (approach instruction). For example, the user notification unit 45 displays a message prompting the user to approach the scanner to be used via the output device 36 (see FIG. 6). The user performs an operation (action) of approaching the scanner according to the instruction given in Step S103 to approach the scanner to be used (Step S104). Specifically, the user approaches the scanner A to be used while carrying the user terminal 3. However, even when the notification to prompt the user to approach the scanner is output, the user may not approach the scanner (operation of Step S104 may not be performed) for some reason. For this reason, the processing of Step S104 is represented by a dotted line in FIG. 7. The process then proceeds to Step S106.

In Step S105, information on the user terminal 3 that is located less than the predetermined distance from the scanner 1 (scanner A) is stored. The storage unit 24 stores information on the user terminal 3 whose distance from the scanner 1 (scanner A) measured by the first distance measurement unit 23 in the distance measurement started in Step S102 meets a predetermined condition (for example, the distance is less than a predetermined distance).

In Step S106, it is determined whether a button to be pressed when the user is unable to approach the scanner while carrying the user terminal 3 is pressed on the user terminal 3. In the description of the present embodiment, the button to be pressed when the user is unable to approach the scanner while carrying the user terminal 3 is referred to as simply “no-approach button.” The selection unit 46 determines whether the button (see the button 72 in FIG. 6) to be pressed when the user terminal 3 is failed to be brought close to the scanner to be used is pressed by the user. When the “no-approach” button is pressed (Yes in Step S106), the process proceeds to Step S201. On the other hand, when the “no-approach” button is not pressed (No in Step S106), the process proceeds to Step S107.

In Step S107, the user terminal 3 determines whether the distance between the scanner 1 and the user terminal 3 meets a distance-related condition (whether the distance is less than the predetermined distance). The selection unit 46 determines whether the distance measured by the second distance measurement unit 431 in the distance measurement started in Step S101 is less than the predetermined distance. For example, whether each of the distance from the own device to the scanner 1a, the distance from the own device to the scanner 1b, and the distance from the own device to the scanner 1c is less than the predetermined distance is determined. When the distance from the own device to any of the scanners is less than the predetermined distance (Yes in Step S107), the process proceeds to Step S301. In this flow, a case where the distance from the own device to the scanner A is less than the predetermined distance is described. On the other hand, when none of the distances from the own device to the scanners is less than the predetermined distance (No in Step S107), the process proceeds to Step S108. The “predetermined distances” used for the distance determination in the scanner A and the user terminal 3 may be the same distance or different distances that can be used to determine that the own device and another device are close to each other.

In Step S108, the user terminal 3 determines whether a predetermined time has elapsed. The selection unit 46 checks whether the predetermined time has elapsed from a time such as when the approach instruction is output in Step S103. When the predetermined time has not elapsed (No in Step S108), the process returns to Step S106. On the other hand, when the predetermined time has elapsed (Yes in Step S108), the process proceeds to Step S109.

In Step S109, the user terminal 3 outputs an error notification. The user notification unit 45 outputs an error notification to notify the user of the occurrence of an error. However, in Step S109, instead of the error notification, a notification instructing the user to approach the scanner to be used may be output again, or a list of connectable scanners may be displayed to prompt the user to select a scanner. Then, the process illustrated in the flowchart ends.

In Step S201, the user terminal 3 displays a list of scanners (scanner list). The list of scanners may be referred to as a scanner list in the following description. The display control unit 44 displays information on the scanners 1 (for example, the scanner 1a, the scanner 1b, and the scanner 1c illustrated in FIG. 1) (scanner list) that are sources of the advertising received by the second signal reception unit 42. In Step S201, a list of connectable scanners corresponding to a model selected on the model selection screen 50 may be displayed. Further, instead of displaying the scanner list in the scanner application, the connectable scanners may be displayed on a screen such as a BLUETOOTH setting screen. The process then proceeds to Step S202.

In Step S202, the user selects a device (apparatus) to be connected. The scanner 1 to be wirelessly connected (the scanner 1 to be used) is manually selected by the user from the scanner list displayed in Step S201. Thus, the selection reception unit 432 receives the selection of the scanner to be wirelessly connected. In this flow, a case where the scanner A is selected by the user is exemplified. The process then proceeds to Step S203.

In Step S203, a pairing request is transmitted from the user terminal 3 to the selected scanner using UUID B. The selection unit 46 determines to perform authentication with the scanner A using an authentication method with relatively high mis-pairing prevention performance in response to the scanner A being selected (specified) by the user as an apparatus to be connected. Specifically, the selection unit 46 determines (selects) to perform authentication with the scanner A using Passkey Entry (UUID B) that is the authentication method with the higher mis-pairing prevention performance of the two authentication methods corresponding to the two UUIDs received from the scanner A in Step S101. That is, executing pairing with priority given to avoiding (reducing) the risk of communicating with an unintended apparatus is selected. Accordingly, the second pairing unit 47 transmits, to the scanner A, a pairing request with the UUID B specified. In this case, the user may select to perform authentication using Passkey Entry (UUID B) because the distance between the scanner A and the user terminal 3 is not less than the predetermined distance. Further, performing authentication using Passkey Entry (UUID B) may be selected by the user pressing a button to be pressed when the user is unable to bring the user terminal 3 close to the scanner to be used. The process then proceeds to Steps S204 and S205.

In Step S204, a PIN code is displayed on the scanner A. The first pairing unit 25 of the scanner A displays the PIN code via the output device 16. As described above, the first pairing unit 25 of the scanner A performs authentication using Passkey Entry based on the pairing request received in Step S203 and specifying the UUID B. The process then proceeds to step S206.

In Step S205, a PIN code input screen is displayed on the user terminal 3. The second pairing unit 47 displays a screen for inputting a PIN code via the output device 36. The process then proceeds to step S206.

In Step S206, the user inputs a PIN code. The PIN code displayed on the scanner is input via the input device 35 of the user terminal 3 by the user who has approached the scanner to be used. The process then proceeds to step S207.

In Step S207, the PIN code is transmitted from the user terminal 3. The second pairing unit 47 transmits the PIN code input in Step S206 to the scanner A. The process then proceeds to step S208.

In Step S208, the scanner A determines whether the PIN code is correct. The first pairing unit 25 determines whether the PIN code transmitted in Step S207 is correct. Specifically, whether the PIN code transmitted in Step S207 matches the PIN code displayed in Step S204 (the PIN code stored in the scanner A). When the PIN code is not correct (not matched) (No in Step S208), the process proceeds to Step S209. On the other hand, when the PIN code is correct (matched) (Yes in Step S208), the process proceeds to Step S210.

In Step S209, the scanner A notifies the user terminal 3 of an error. The first pairing unit 25 notifies the user terminal 3 that the authentication (pairing) has failed (an error has occurred). The process then proceeds to Step S211.

In Step S210, the scanner A notifies the user terminal 3 of the success. The first pairing unit 25 notifies the user terminal 3 that the authentication (pairing) has succeeded (transmission of a pairing response). The process then proceeds to Step S211.

In Step S211, whether the result is an error or success is determined. The user terminal 3 determines whether the notification from the scanner A indicates an error or success. When the notification indicates an error (“error” in Step S211), the process proceeds to Step S212. On the other hand, when the notification indicates success (“success” in Step S211), the process proceeds to Step S213.

In Step S212, the user terminal 3 outputs an error notification. The user notification unit 45 outputs an error notification to notify the user that the authentication (pairing) has failed (an error has occurred). Then, the process illustrated in the flowchart ends.

In Step S213, the user terminal 3 transmits WI-FI setting information (e.g., an SSID and a password) to the scanner A. A setting information transmission unit of the user terminal 3 transmits setting information for wireless communication in accordance with another wireless communication standard (second wireless communication standard (for example, WI-FI)) that is different from the first wireless communication standard to the scanner A, by wireless communication (BLUETOOTH communication) in accordance with the first wireless communication standard. Specifically, a setting information acquisition unit of the user terminal 3 acquires the setting information for wireless communication in accordance with the second wireless communication standard by reading the setting information stored in the user terminal 3, receiving an input of the setting information by the user, or reading a code (e.g., one-dimensional code or two-dimensional code) for identifying the setting information. Then, the setting information transmission unit transmits the setting information acquired by the setting information acquisition unit to the scanner A. The process then proceeds to Step S214.

In Step S214, the scanner A sets up WI-FI settings and connection. A setting unit of the scanner A sets up for wireless communication (WI-FI communication) in accordance with the second wireless communication standard using the setting information transmitted in Step S213, thereby connecting the scanner A to WI-FI. As described above, by setting up WI-FI settings with the WI-FI setting information using the BLUETOOTH communication, the time and effort of the user to set up the WI-FI settings can be reduced. Then, the process illustrated in the flowchart ends.

In Step S301, the user terminal 3 transmits a pairing request using UUID A to the scanner (scanner A) located less than a predetermined distance from the user terminal 3. First, in Step S107, the selection unit 46 determines to perform authentication with the scanner A by an authentication method with relatively low mis-pairing prevention performance in response to the determination that the distance between the user terminal 3 and the scanner A is less than the predetermined distance. As described above, when the distance between the user terminal 3 and the scanner A is short, as described above, the risk such as spoofing is low. Further, because the user terminal 3 is brought close to (is near) the scanner A after an instruction to approach the scanner A to be used, the risk such as misidentification can be estimated to be low. The selection unit 46 determines (selects) to perform authentication with the scanner A using Just Works (UUID A) that is the authentication method with the lower mis-pairing prevention performance of the two authentication methods corresponding to the two UUIDs received from the scanner A in Step S101. That is, pairing that prioritizes simplifying the user operation is selected for execution. In this case, approaching the scanner A to a distance of less than the predetermined distance also serves as the criterion for scanner selection. The second pairing unit 47 transmits a pairing request with the UUID A specified to the scanner A. When pairing using Just Works is performed, the second pairing unit 47 may cause the output device 36 to display a screen for selecting whether to permit pairing in advance, and receive pairing permission from the user. The process then proceeds to Step S302.

In Step S302, pairing is permitted on the scanner A. The first pairing unit 25 receives the pairing request transmitted in Step S301, performs pairing by Just Works between the own apparatus (scanner A) and the user terminal 3 based on the pairing request, and completes the pairing. At this time, the first pairing unit 25 transmits a pairing response to the user terminal 3. Each of the scanner A and the user terminal 3 may store encrypted information generated and exchanged in the pairing. The process then proceeds to Step S303.

In Step S303, whether information on the user terminal 3 is stored in the scanner A is determined. The first pairing unit 25 determines whether the information on the user terminal 3 that has transmitted the pairing request in Step S301 is stored in Step S105. Whether the information on the user terminal 3 is stored may be determined by another function unit (a determination unit). When the information on the user terminal 3 is not stored (No in Step S303), the process proceeds to Step S304. On the other hand, when the information on the user terminal 3 is stored (Yes in Step S303), the process proceeds to Step S306.

In Steps S304 and S305, the scanner A cancels the pairing and outputs an error notification to the user terminal 3. The first pairing unit 25 cancels the pairing with the user terminal 3 and notifies the user terminal 3 that an error has occurred (that the user terminal 3 is determined not to be close to the scanner A (or not to be located less than a predetermined distance from the scanner A)). This can prevent a malicious user from connecting to the scanner indiscriminately (connecting and changing settings, etc.). The process then proceeds to Step S307.

In Step S306, the scanner A transmits a success notification to the user terminal 3. The first pairing unit 25 notifies the user terminal 3 that the scanner A also confirms that the user terminal 3 is approaching (the success). The process then proceeds to Step S307. In Step S302 or Step S306, the user terminal 3 may output a pairing completion notification to notify the user of completion of the pairing. However, Step S306 may be omitted. In this case, the process may proceed to Step S309 when Step 307 does not determine an error.

In Step S307, whether error or success is determined. The user terminal 3 determines whether the notification from the scanner A indicates an error or success. In the case of an error (“error” in Step S307), the process proceeds to Step S308. On the other hand, when the notification indicates success (“success” in Step S307), the process proceeds to Step S309.

In Step S308, the user terminal 3 outputs an error notification. The user notification unit 45 outputs a notification to notify the user that the pairing has failed (an error has occurred). Then, the process illustrated in the flowchart ends.

In Steps S309 and S310, the user terminal 3 transmits WI-FI setting information to the scanner A, and the scanner A sets up WI-FI settings and connection. The processing of Step S309 and Step S310 is substantially the same as the processing of Step S213 and Step S214, and thus the description thereof is omitted. Then, the process illustrated in the flowchart ends.

As described above, in this flowchart, pairing without authentication (pairing that prioritizes user convenience) is performed when the user terminal 3 is brought close to the scanner in accordance with an instruction (guidance) to bring the user terminal 3 close to the scanner, and pairing with authentication (pairing that prioritizes reducing the risk of communicating with an unintended apparatus (e.g., security)) is performed when the user terminal 3 is not brought close to the scanner (when a notification indicating that the user terminal 3 is not brought close to the scanner is received according to a user operation).

As described above, according to the present embodiment, the risk of communicating with an unintended apparatus can be appropriately avoided by selecting an authentication method with mis-pairing prevention performance suitable for the predetermined information available for estimating the risk of communicating with an unintended apparatus and performing authentication with an electronic apparatus by the selected authentication method. As described above, when the authentication method has low mis-pairing prevention performance, the user operation related to authentication tends to be simple. On the other hand, when the authentication method has high mis-pairing prevention performance, the user operation related to authentication tends to be complicated (increase the user's time and effort). Accordingly, the risk of communicating with an unintended apparatus can be reduced (ensuring security and avoiding communication with an incorrectly selected scanner can be archived) while the user's time and effort in establishing a wireless connection (pairing) is reduced, by selecting an authentication method with mis-pairing prevention performance suitable for the predetermined information available for estimating the risk of communicating with an unintended apparatus and performing authentication with an electronic apparatus by the selected authentication method. For example, as described above, the risk of communicating with an unintended apparatus varies depending on the distance between the user (user terminal 3) and the scanner 1. Accordingly, when the user terminal 3 is brought close to the scanner 1, the risk including misidentification and spoofing is extremely low, and thus pairing can be performed with priority on ease of use (user convenience) by connection using the second authentication method (for example, Just Works). On the other hand, when the user terminal 3 is not brought close to the scanner 1, the risk including misidentification and spoofing increases. Accordingly, pairing can be performed by connection using the first authentication method (for example, Passkey Entry), with priority given to reducing the risk of communicating with an unintended apparatus (priority given to security). As described above, according to the present embodiment, by selecting an authentication method suitable for information such as the distance, the balance between reducing the user's time and effort and reducing the risk of communicating with an unintended apparatus can be optimized. That is, a pairing method (authentication method) that achieves both the simplicity of the user operation and the safety in an optimal balance can be selected.

### First Variation

In the above-described embodiment, the authentication method is selected based on the distance between the scanner 1 and the user terminal 3 and the scanner selection by the user, but the authentication method may be selected according to the model of the user terminal 3. A first variation of the above-described embodiment is described below. In the first variation, the authentication method is selected based on the model of the user terminal 3, the distance between the scanner 1 and the user terminal 3, and the scanner selection by the user is described below. In the description of the present variation below, the description of the configuration common to the above-described embodiment is omitted, and a difference from the above-described embodiment.

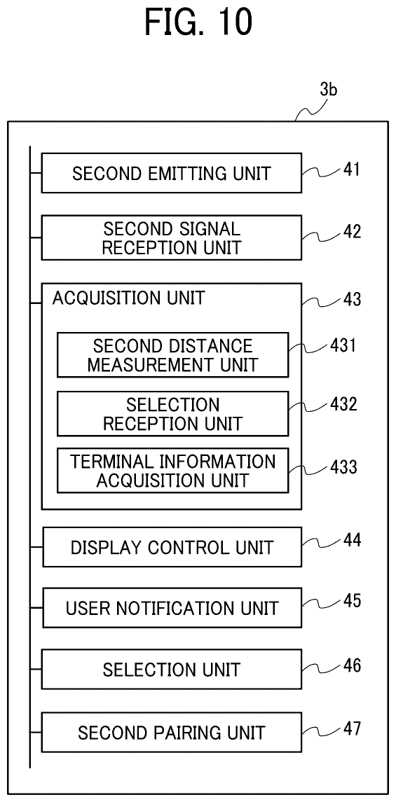

FIG. 10 is a schematic diagram illustrating a functional configuration of an information processing device (user terminal) 3b according to the first variation. In the present variation, the acquisition unit 43 includes a terminal information acquisition unit 433 in addition to the second distance measurement unit 431 and the selection reception unit 432.

The terminal information acquisition unit 433 acquires information on the own device (user terminal 3). Specifically, the terminal information acquisition unit 433 acquires the type of the own device (information indicating the type of the own device). For example, the terminal information acquisition unit 433 acquires information indicating whether the own device is a mobile terminal (portable terminal (device)). For example, the information indicating whether the own device is a mobile terminal (such as a smartphone) or a terminal that is not a mobile terminal (such as desktop personal computer (PC)) is acquired. When the user terminal 3 is not a mobile terminal, the user has difficulty approaching the scanner 1 intended as the connection destination while carrying the user terminal 3. In this case, even when a third party interrupts the pairing with the scanner 1 by connecting to the user terminal 3 to perform snooping by acting as the connection destination, the user may not notice the snooping. By contrast, when the user terminal 3 is a mobile terminal, the user can approach the intended scanner while carrying the user terminal 3, and thus can notice the snooping. Accordingly, when the user terminal 3 is not a mobile terminal, the risk of being snooped (the risk of communicating with an unintended apparatus) can be estimated to be higher than when the user terminal 3 is a mobile terminal. That is, the information indicating whether the user terminal 3 is a mobile terminal can be considered as information available for estimating the risk of communicating with an unintended apparatus. Accordingly, the information indicating whether the user terminal 3 is a mobile terminal is an example of the predetermined information.

Further, the terminal information acquisition unit 433 may acquire information indicating whether the own device is a predetermined (specific) model (e.g., a model with a higher risk of communicating with an unintended apparatus) as the type of the own device. For example, the information indicating whether the own device supports only versions earlier than BLUETOOTH 4.2 is acquired. Versions earlier than BLUETOOTH 4.2 can be considered as being more likely to be exposed to security risks (including a risk of communicating with an unintended apparatus) than BLUETOOTH 4.2 and later versions. Accordingly, when the user terminal 3 is a predetermined model (e.g., a model corresponding to only versions earlier than BLUETOOTH 4.2), the risk of communicating with an unintended apparatus can be estimated to be higher than when the user terminal 3 is not a predetermined model. That is, the information indicating whether the user terminal 3 is a predetermined model can be considered as information available for estimating the risk of communicating with an unintended apparatus. Accordingly, the information indicating whether the user terminal 3 is of the predetermined model is an example of the predetermined information. As described above, the acquisition unit 43 can acquire the type of the own device as the predetermined information by the terminal information acquisition unit 433 acquiring the type of the own device. A method of selecting an authentication method according to the type of the own device is described below.

### Method of Selecting Authentication Method Based on Type of Own Device

The selection unit 46 selects an authentication method with mis-pairing prevention performance suitable for the type of the own device. The type of the own device is acquired by the acquisition unit 43 (the terminal information acquisition unit 433). In the description of the present variation, an authentication method with mis-pairing prevention performance suitable for the type of the own device is selected without considering the type of the scanner. For example, as described above, when the own device is not a mobile terminal, the risk of being snooped (the risk of communicating with an unintended apparatus) can be estimated to be high (or present). When the risk is estimated to be high as described above, it is desirable to use an authentication method with high (relatively high) mis-pairing prevention performance. Although the user operations required in using an authentication method with high mis-pairing prevention performance such as Passkey Entry tend to be complicated due to an additional user operation related to authentication (pairing), reducing the risk is prioritized in using such an authentication method. As described above, the selection unit 46 may select an authentication method with mis-pairing prevention performance suitable for a situation where the own device is not a mobile terminal. In other words, the selection unit 46 may select the first authentication method that has higher mis-pairing prevention performance than the second authentication method and that is suitable for a situation where the risk of communicating with an unintended apparatus can be estimated to be high. Further, for example, as described above, when the own device is a predetermined model (a model having a higher risk of communicating with an unintended apparatus), the own device is highly likely to be exposed to a security risk (including a risk of communicating with an unintended apparatus). As described above, when the risk can be estimated to be high, an authentication method with high (relatively high) mis-pairing prevention performance is preferably used. That is, the selection unit 46 may select an authentication method with mis-pairing prevention performance suitable for a situation where the own device is a predetermined model. In other words, the selection unit 46 may select the first authentication method that has higher mis-pairing prevention performance than the second authentication method and that is suitable for a situation where the risk of communicating with an unintended apparatus can be estimated to be high.

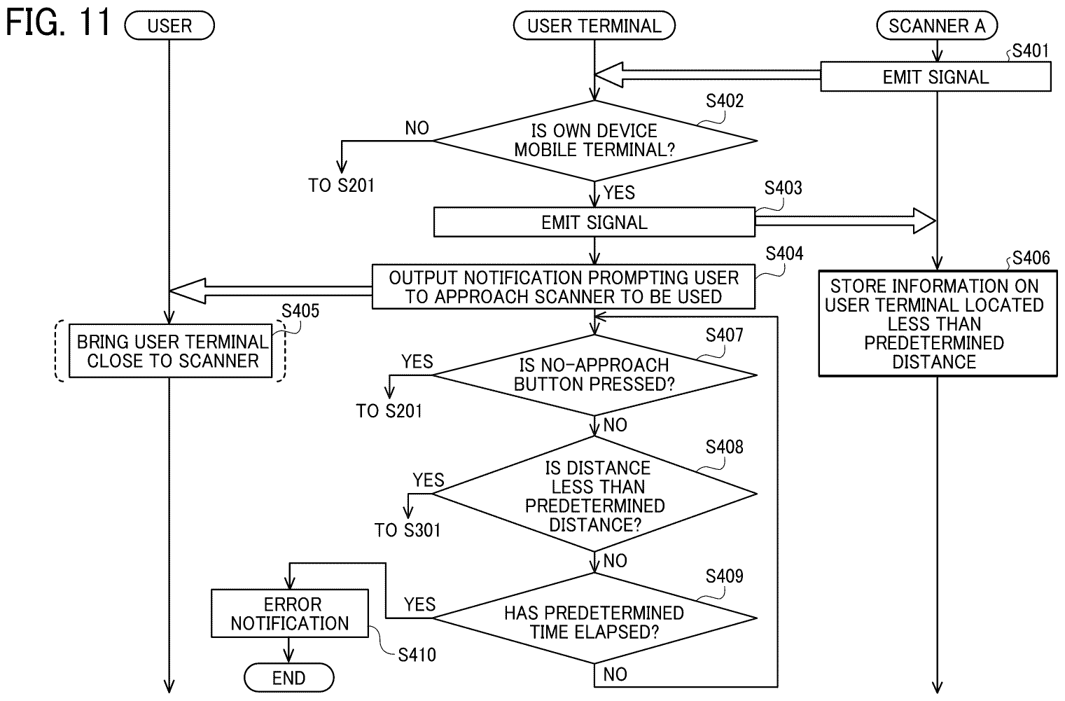

FIG. 11 is a flowchart and communication sequence diagram illustrating an overview of a pairing process according to the first variation. The process illustrated in the flowchart starts when a user operation is performed on the user terminal 3 to start the scanner application or when a scanner model is selected on the model selection screen.

In Step S401, the scanner A emits a signal. The scanner 1 (first emitting unit 21) emits advertising, and the user terminal 3 (second signal reception unit 42) receives advertising emitted by the first emitting unit 21. The processing of Step S401 is substantially the same as the processing of Step S101. The process then proceeds to Step S402.

In Step S402, the user terminal 3 determines whether the own device is a mobile terminal. First, the terminal information acquisition unit 433 acquires information on the own device (the type of the own device), and the selection unit 46 determines whether the own device is a mobile terminal based on the acquired information. When the own device is not a mobile terminal (No in Step S402), the process proceeds to Step S201. As described above, when the own device is determined not to be a mobile terminal, the selection unit 46 may select (determine) an authentication method that is the first authentication method having mis-pairing prevention performance higher than the second authentication method, based on the determination result. On the other hand, when the own device is a mobile terminal (Yes in Step S402), the process proceeds to Step S403.

In Step S403, the user terminal 3 emits a signal. The user terminal 3 (second emitting unit 41) emits advertising, and the scanner 1 (first signal reception unit 22) receives advertising emitted by the second emitting unit 41. The processing of Step S403 is substantially the same as the processing of Step S102. The process then proceeds to Steps S404 and S406. The processing of Steps S404 to S410 is substantially the same as the processing of Steps S103 to S109, and thus the description thereof is omitted.

As in this variation, pairing may be performed by an authentication method with relatively high mis-pairing prevention performance (for example, with relatively high security) appropriate for the determination result indicating that the own device is not a mobile terminal (No in Step S402).

### Second Variation

In the above-described embodiment, a scanner list (scanner selection screen) is displayed when a user input indicating that the user fails to approach the scanner is received or when the user terminal 3 is not brought close to the scanner 1 within a predetermined period. In a second variation, a scanner list is displayed when advertising is received from the scanner 1. In the description of the present variation below, the description of the configuration common to the above-described embodiment is omitted, and a difference from the above-described embodiment is described.

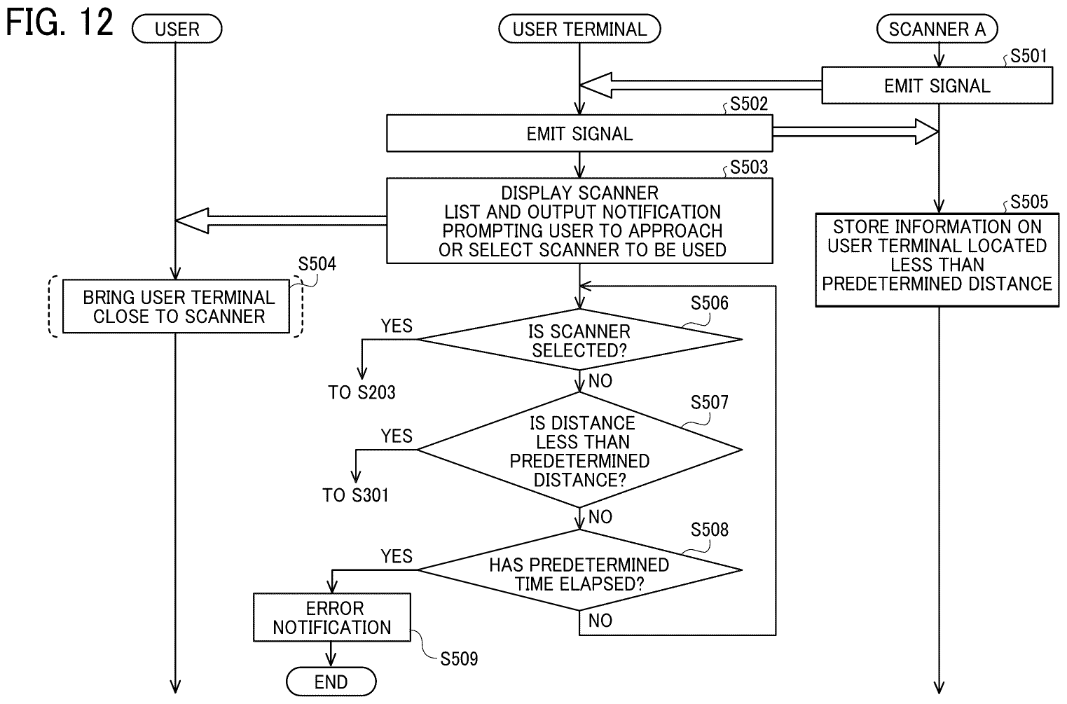

FIG. 12 is a flowchart and a communication sequence diagram illustrating an overview of a pairing process according to the second variation. The process illustrated in the flowchart starts when a user operation is performed on the user terminal 3 to start the scanner application or when a scanner model is selected on the model selection screen.

In Step S501, the scanner 1 emits advertising (signal). In Step S502, the user terminal 3 emits advertising (signal). The processing of Step S501 and Step S502 is substantially the same as the processing of Step S101 and Step S102, and thus the description thereof is omitted. The process then proceeds to Steps S503 and S505.

In Step S503, the user terminal 3 displays a scanner list, and outputs a notification instructing the user to approach a scanner to be used or to select a scanner to be used.

The display control unit 44 displays information on the scanners 1 (scanner list) that are sources of the advertising received by the second signal reception unit 42. The user notification unit 45 displays a message prompting the user to approach the scanner to be used or to select the scanner to be used from the scanner list via the output device 36. The process then proceeds to Step S504. The processing of Step S504 and Step S505 is substantially the same as the processing of Step S104 and Step S105, and thus, the description thereof is omitted.

In Step S506, whether a scanner is selected is determined. The selection unit 46 determines whether the selection reception unit 432 has received a scanner selection from the user. When a scanner is selected (Yes in Step S506), the process proceeds to Step S203. On the other hand, when a scanner is not selected (No in Step S506), the process proceeds to Step S507. The processing of Steps S507 to S509 is substantially the same as the processing of Steps S107 to S109, and thus the description thereof is omitted.

As in this variation (Step S503), the scanner list may be displayed when advertising is received from the scanner 1.

### Third Variation

In the above-described embodiment, the first authentication method, whose mis-pairing prevention performance is higher than that of the second authentication method, is selected in response to a scanner selection from the user. In the following description of the variation, a case where the second authentication method, whose mis-pairing prevention performance is lower than that of the first authentication method, is selected in response to a scanner selection and a user operation for bringing the user terminal 3 close to the selected scanner is given as an example. In the description of the present variation below, the description of the configuration common to the above-described embodiment is omitted, and a difference from the above-described embodiment is described.

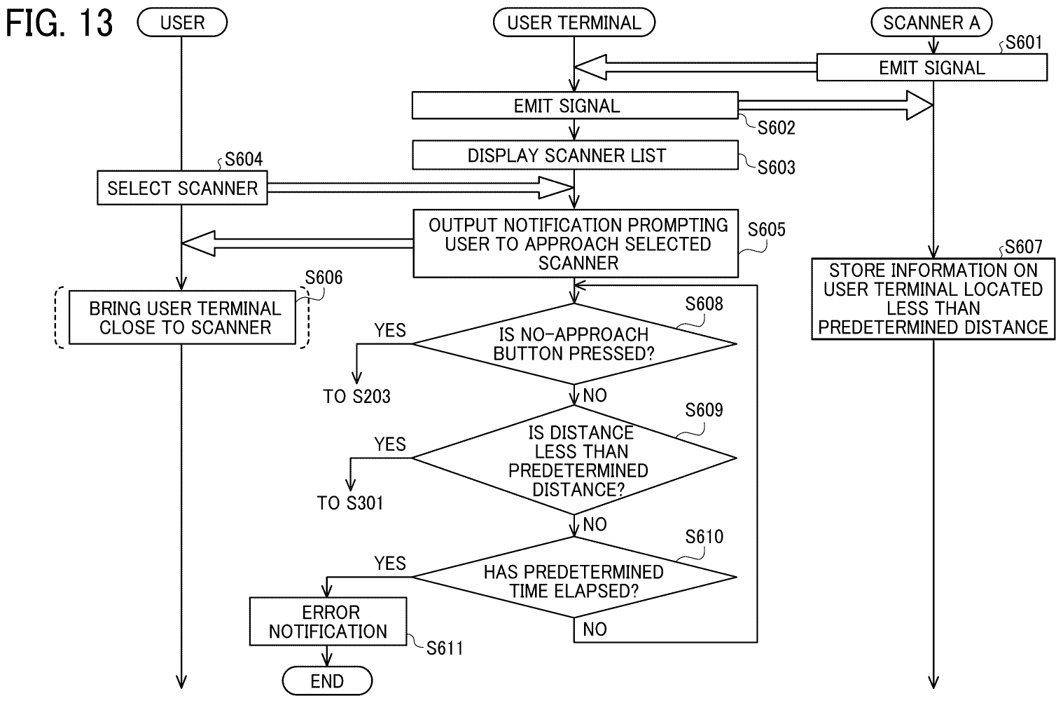

FIG. 13 is a flowchart and a communication sequence diagram illustrating an overview of a pairing process according to the third variation. The process illustrated in the flowchart starts when a user operation is performed on the user terminal 3 to start the scanner application or when a scanner model is selected on the model selection screen.

In Step S601, the scanner 1 emits advertising (signal). In Step S602, the user terminal 3 emits advertising (signal). The processing of Step S601 and Step S602 is substantially the same as the processing of Step S101 and Step S102, and thus, the description thereof is omitted. The process then proceeds to Step S603. The processing of Step S603 and Step S604 is substantially the same as the processing of Step S201 and Step S202, and thus, the description thereof is omitted.

In Step S605, the user terminal 3 outputs a notification to prompt the user to approach the scanner selected in Step S604. For example, the user notification unit 45 displays a message prompting the user to approach the selected scanner, via the output device 36. The process then proceeds to Step S606. The processing of Steps S606 to S611 is substantially the same as the processing of Steps S104 to S109, and thus the description thereof is omitted. However, in this variation, when the no-approach button is pressed in Step S608, the process proceeds to Step S203.

As in this variation, even when the user selects a scanner (Step S604), the second authentication method, which has mis-pairing prevention performance lower than the first authentication method, may be selected when the user terminal 3 is brought close to the selected scanner (Yes in Step S609). The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

In the related art, wireless communication is established according to wireless communication standards such as BLUETOOTH (registered trademark). In such wireless communication, a risk of communicating with an unintended apparatus may occur.

The present disclosure can be understood as an information processing device, a system, a method executed by a computer, or a program executed by a computer. Further, the present disclosure can also be understood as a recording medium that stores such a program and that can be read by, for example, a computer or any other apparatus or machine. The recording medium that can be read by, for example, the computer refers to a recording medium that can store information such as data or programs by electrical, magnetic, optical, mechanical, or chemical action, and that can be read by, for example, a computer.

According to one or more aspects of the present disclosure, the risk of communicating with an unintended apparatus can be appropriately avoided.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc read-only memory (CD-ROM) or digital versatile disc (DVD), and/or the memory of an FPGA or ASIC.

1. An information processing device, comprising circuitry configured to:
receive a plurality of identifiers from an electronic apparatus that emits the plurality of identifiers each corresponding to one of a plurality of authentication methods, wherein each of the plurality of authentication methods has corresponding mis-pairing prevention performance regarding a risk of communicating with an unintended apparatus;
acquire predetermined information available for estimating the risk of communicating with the unintended apparatus;
select an authentication method having mis-pairing prevention performance suitable for the predetermined information from among the plurality of authentication methods; and
perform authentication with the electronic apparatus using the selected authentication method for wireless communication in accordance with a wireless communication standard.

2. The information processing device of claim 1, wherein
the circuitry is further configured to:
measure a distance between the electronic apparatus and the information processing device to acquire the predetermined information indicating the distance; and
select the authentication method having the mis-pairing prevention performance suitable for the distance.

3. The information processing device of claim 2, wherein
the plurality of authentication methods includes a first authentication method and a second authentication method, wherein the second authentication method has lower mis-pairing prevention performance than the first authentication method, and
the circuitry is configured to select the second authentication method when the distance between the electronic apparatus and the information processing device meets a distance-related condition.

4. The information processing device of claim 3, wherein
the electronic apparatus includes a plurality of electronic apparatuses each of which is available to perform authentication for wireless communication in accordance with the wireless communication standard with the information processing device, and
the circuitry is further configured to:
acquire distances each corresponding to a distance between the information processing device and a corresponding one of the plurality of electronic apparatuses;
select the second authentication method for authentication with one of the plurality of electronic apparatuses, wherein the one of the plurality of electronic apparatuses corresponds to one of the distances that meets the distance-related condition; and
perform the authentication with the one of the plurality of electronic apparatuses using the second authentication method.

5. The information processing device of claim 4, wherein
the circuitry is further configured to output a notification to prompt a user to approach an electronic apparatus to be used.

6. The information processing device of claim 3, wherein
the circuitry is further configured to emit a predetermined signal to be used by the electronic apparatus to measure the distance between the information processing device and the electronic apparatus; and
output an error notification when the distance does not meet the distance-related condition.

7. The information processing device of claim 2, wherein
the plurality of authentication methods includes a first authentication method and a second authentication method, wherein the second authentication method has lower mis-pairing prevention performance than the first authentication method, and
the circuitry is configured to select the first authentication method when the distance between the electronic apparatus and the information processing device does not meet a distance-related condition.

8. The information processing device of claim 7, wherein
the circuitry is configured to select the first authentication method when the distance between the electronic apparatus and the information processing device does not meet the distance-related condition within a predetermined time period.

9. The information processing device of claim 1, wherein
the circuitry is configured to:
acquire the predetermined information indicating a type of the information processing device; and
select the one of the plurality of authentication methods having the mis-pairing prevention performance suitable for the type of the information processing device.

10. The information processing device of claim 9, wherein
the plurality of authentication methods includes a first authentication method and a second authentication method, wherein the second authentication method has lower mis-pairing prevention performance than the first authentication method, and
the circuitry is configured to select the first authentication method when the type of the information processing device indicates that the information processing device is not portable.

11. The information processing device of claim 9, wherein
the plurality of authentication methods includes a first authentication method and a second authentication method, wherein the second authentication method has lower mis-pairing prevention performance than the first authentication method, and
the circuitry is configured to select the first authentication method when the information processing device is a predetermined model.

12. The information processing device of claim 1, wherein
the plurality of authentication methods includes a first authentication method and a second authentication method, wherein the second authentication method has lower mis-pairing prevention performance than the first authentication method,
the electronic apparatus is one of one or more of electronic apparatuses each of which is available to perform authentication for wireless communication in accordance with the wireless communication standard with the information processing device,
the predetermined information indicates whether the one of the one or more of electronic apparatuses is specified as a target apparatus to perform the authentication with the information processing device, and
the circuitry is configured to select the first authentication method when the one of the one or more of electronic apparatuses is specified as the target apparatus.

13. The information processing device of claim 1, wherein
the plurality of authentication methods includes a first authentication method and a second authentication method, wherein the second authentication method has lower mis-pairing prevention performance than the first authentication method,
the first authentication method is one of:
an authentication method including an operation for confirming that a connection destination is correct; and
a method combining an authentication method that does not include the operation for confirming that a connection destination is correct and a method of requesting to perform a predetermined operation related to an electronic apparatus intended as a connection target, and
the second authentication method is an authentication method that does not include the operation for confirming that a connection destination is correct and that does not request to perform the predetermined operation.

14. The information processing device of claim 1, wherein
the plurality of identifiers is a plurality of service universally unique identifiers (UUIDs).

15. An information processing device, comprising circuitry configured to:
receive a plurality of identifiers corresponding to a plurality of authentication methods from an electronic apparatus;
select an authentication method for authentication of the electronic apparatus from among the plurality of authentication methods based on predetermined information available for estimating a risk of communicating with an unintended apparatus; and
perform the authentication of the electronic apparatus using the selected authentication method.

16. An information processing system, comprising:
an electronic apparatus including first circuitry; and
an information processing device including second circuitry, wherein the information processing device performs authentication for wireless communication in accordance with a wireless communication standard with the electronic apparatus, wherein
the first circuitry is configured to emit a plurality of identifiers corresponding to a plurality of authentication methods each having corresponding mis-pairing prevention performance regarding a risk of communicating with an unintended apparatus;
the second circuitry is configured to:
receive the plurality of identifiers;
acquire predetermined information available for estimating the risk of communicating with the unintended apparatus;
select an authentication method having mis-pairing prevention performance suitable for the predetermined information from among the plurality of authentication methods; and
perform the authentication with the electronic apparatus using the selected authentication method.

17. The information processing system of claim 16, wherein
the second circuitry is configured to:
measure a distance between the electronic apparatus and the information processing device to acquire the predetermined information indicating the distance; and
select the authentication method having mis-pairing prevention performance suitable for the distance, and
the first circuitry is configured to:
measure the distance between the electronic apparatus and the information processing device; and
disconnect the wireless communication established by the authentication using the selected authentication method when the distance measured by the first circuitry does not meet a predetermined condition.
